(19) United States
(12) Patent Application Publication
(10) Pub. No.: US 2010/0333079 A1
(43) Pub. Date: Dec. 30, 2010

(54) Binary Code Modification System and Method for Implementing Identity and Access Management or Governance Policies

(75) Inventors: Yakov I. Sverdlov, Newton, MA (US); Milan Shah, Hopkinton, MA (US); Ramesh Natarajan, Northborough, MA (US); Franklin J. Russell, JR., Grafton, MA (US); Herbert P. Mehlhorn, Westford, MA (US); Timothy G. Brown, Fort Edward, NY (US); Gregory M. Gotta, Northbridge, MA (US); J. Matthew Gardiner, Weston, MA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/495,261

(22) Filed: Jun. 30, 2009

(51) Int. Cl. G06F 9/44

(52) U.S. Cl. 717/168

(57) ABSTRACT

According to one embodiment, a binary code modification system includes a code modifier configured to access a binary software code. The code modifier generates a modified software code by inserting one or more executable instructions into the binary software code. The one or more executable instructions is operable to provide identity and access management (IAM) functionality or governance functionality to the modified software code.

### TECHNICAL FIELD OF THE DISCLOSURE

This disclosure generally relates to executable software, and more particularly, to a binary code modification system for implementing identity and access management or governance policies and a method of operating the same.

### BACKGROUND OF THE DISCLOSURE

Software applications generated for use with computing systems are typically compiled from one or more source files into executable binary code. Compiling from source files may provide several advantages over other forms of software, such as those used by command interpreters that execute individual instructions at runtime. For example, executable binary software code compiled from source files may execute relatively faster because operations, statements, declarations, and other coding regimens that enhance human readability are stripped away to provide object code representing machine language instructions that may be directly interpreted by the computing system's processor. In some cases, compiled binary software code may also be useful for hiding specific elements of the source files from which the binary code is generated. In this manner, the compiled binary code may be publicly distributed without revealing specific elements and algorithms used by the binary software code.

### SUMMARY OF THE DISCLOSURE

According to one embodiment, a binary code modification system includes a code modifier configured to access a binary software code. The code modifier generates a modified software code by inserting one or more executable instructions into the binary software code. The one or more executable instructions is operable to provide identity and access management (IAM) functionality or governance functionality to the modified software code.

Some embodiments of the disclosure may provide numerous technical advantages. For example, one embodiment of the binary code modification system may provide enhanced functionality for binary software code without re-compiling from its associated source code. Because, the executable code is not recompiled from source files, dependencies that may adversely affect the proper operation of other portions of code may remain relatively unaffected. Also, enhanced or altered functionality may be provided to software applications such as legacy software for which their associated source files may be difficult to find, may require knowledge of source code that is no longer available due to employee turnover, and whose compilation environment may be difficult to duplicate.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a diagram showing one embodiment of a binary code modification system, which may be used with other embodiments;

FIGS. 2A and 2B are illustrations showing a portion of binary software code and a portion of modified software code, respectively, of FIG. 1;

FIG. 3 is a diagram showing an example embodiment in which code is injected into binary software code to provide identity and access management (IAM) functionality and/or governance functionality;

FIG. 4 is a flowchart showing one embodiment of a series of actions that may be performed to inject identity and access management (IAM) logic and governance logic into binary software code;

FIG. 5 is a diagram showing another example embodiment in which code is injected into binary software code to expose the binary software code as a web service interface (including web service client and a web service endpoint);

FIG. 6 is a flowchart showing one embodiment of a series of actions that may be performed to inject code into binary software code in order to expose the binary software code as a web service interface; and

FIG. 7 presents an embodiment of a general purpose computer operable to perform one or more operations of various embodiments.

### DETAILED DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

Software applications generated for use on computing systems are typically compiled from one or more source files. These source files typically include multiple instructions that are readily read and understood by humans. Binary code generated from these source files, on the other hand, are generally cryptic in nature and thus difficult to read. Due to the generally cryptic nature of binary code, modifications to software applications typically involves modifying source files, and then re-compiling the source files to generate the modified software code.

In some cases, however, re-compiling executable code from modified source files may be extremely difficult, if not impossible. For example, the source files associated with the executable binary code may be unavailable, such as legacy software that may have been compiled in the distant past using source files that have since been lost or discarded. Additionally, re-compilation of executable code may encounter many dependencies such that extensive testing may be required to ensure that the modified portion of executable code did not adversely affect its operation.

For modern day software architectures, identity and access management (IAM) and software governance solutions continue to increase in importance. In general, IAM involves three levels of detail: (1) Resources, (2) Identification, and (3) Policy. The “Resources” level relates to the particular thing that is being protected including hardware and/or software resources such as, but not limited to, OS processes, applications, documents, class methods, database records, and the like. The “Identification” level relates to who (e.g., an appropriate “user”) should get access to the “Resources.” The “Policy” specifies, among other things, authentication and authorization requirements, rules and actions/obligations/responses, associated with the policy execution. An unlimited number of policies can be generated to control which “users” can access particular “Resources” on a system. As used herein, “user” may generally refer to a person, entity, object or device, capable of accessing (but not necessarily authorized) a resource. For example, a user may be a person accessing particular code through a computer. Alternatively, the user may be the computer or software, itself, programmed to access the resource.

Governance, in general, relates to logic that complies with a particular “governance” policy. In general, the governance policy defines what software and/or hardware can or cannot do. Similar to IAM, a virtual limitless number of governance policies can be defined. As non-limiting examples, a governance policy may govern event generation criteria, control software execution, and monitor any of a variety of information on a system. These governance policies are sometimes referred to as governance, risk and compliance (GRC) policies.

Because of the inability to modify binary code, two conventional approaches have been taken in implementing IAM and/or governance solutions with, for example, legacy code or other code.

The first conventional approach involves “fronting” an application (or legacy code) or intercepting requests sent to the application (or legacy code) using an external Policy Enforcement Point (PEP). In such a process, the PEP would collect necessary data (e.g., identification and/or application parameters) and then pass them to the Policy Decision Point (PDP). The PDP would evaluate an authentication and/or an authorization policy and the policy decision (by PDP) would be enforced by PEP. The problem with this approach is that it inefficiently adds an extra layer of processing. Further, it doesn't allow the flexibility that may be desired with some IAM and/or governance solutions.

The second conventional approach involves embedding PEP logic (which may also include PDP logic) within the application during development time—in other words, prior to compilation. For example, before the code is compiled, a commercial or proprietary API may be imbedded within the code allowing communication with an external (or embedded) PDP to evaluate authentication and/or authorization policies. The problem with this approach is that it is unavailable when, as indicated above, there is no access to the source files. Another problem is that in many instances, embedding IAM/governance logic at development time may not be a good idea. For example, it may be desirous to exclude developers from “hard coding” IAM/governance decisions into the original source code.

For modern day software architectures, it is additionally important to have web service access for particular functionality. However, it is often the case that code (e.g., legacy code) does not support the particular desired web service access. Additionally, as indicated above, there may be an inability to modify and recompile source code to enable the code (e.g., legacy code) to communicate using web service access, let alone communicate using particular web protocols such as XML.

Accordingly, teachings of certain embodiments recognize techniques that modify binary code without recompiling it. Further, teachings of certain embodiments recognize various applications that can benefit from injection of additional code in the existing binary code. For example, in one embodiment, code may be injected into existing binary code in order to provide IAM and/or governance solutions for the existing binary code. As another example, in another embodiment, code may be injected into existing binary code in order to expose the existing application logic as a web service interface (including web service client and a web service endpoint).

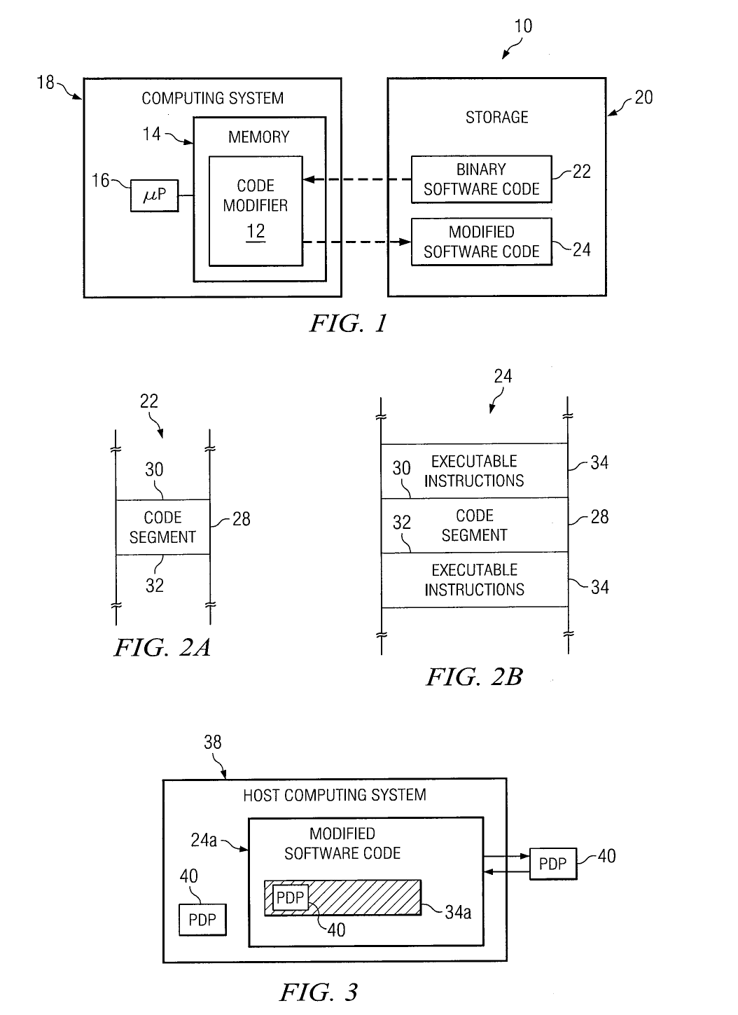

FIG. 1 is a diagram showing one embodiment of a binary code modification system 10, which may be used with other embodiments. The binary code modification system 10 includes a code modifier 12 stored in a memory 14 and executed on a processor 16 of a computing system 18. Storage 20 may be a component of the computing system 18 or may form a component of another computing system (not shown). Storage 20 stores existing binary software code 22 and/or modified software code 24 generated from code modifier 12. To generate modified software code 24, code modifier 12 accesses binary software code 22 from storage 20 or other suitable source, inserts one or more executable instructions into the binary software code 22 and stores it as modified software code 24 in storage 20.

As a non-limiting examples, in one embodiment, the binary code may be taken through the code modifier 12 to generate modified software code 24. In such an embodiment, after such modification, the application (with modified software code 24) may be restarted to begin processing the modified software code 24. In other embodiment, the application may not be restarted. Rather, code may be injected inside of a java virtual machine (JVM) at run-time. In other embodiments, code may be injected into the binary software code 22 in other manners in order to yield modified software code 24.

In various embodiments, the modified software code 24 may be executed by a suitable host computing system with additional functionality provided by the one or more inserted executable instructions.

In certain embodiments, code modifier 12 may provide an advantage in that additional functionality may be provided to certain code segments of binary software code in a relatively efficient manner. Because the executable code is not recompiled from source files, dependencies that may adversely affect the proper operation of other portions of code may remain relatively unaffected. Also, enhanced functionality may be provided to software applications such as legacy software for which their associated source files may be difficult to find and whose compilation environment may be difficult to duplicate. In some embodiments, functionality may be provided for binary software code 22 that was not previously available. For example, as will be described with reference to embodiments below, the injected code may provide identity and access management (IAM) functionality and/or governance functionality. Additionally, in certain embodiments, the injected code may expose existing code to a web service interface.

Binary software code 22 may include any type of software code that has been compiled by a compiler. Binary software code 22 generally refers to object level code or machine language instructions that may be executed on a suitable computing system. Examples of binary software code 22 includes, but is not limited to, Java software code, C, C++, model view controller (MVC) code, common business oriented language (COBOL) software code, those written to conform to the Microsoft™ “.NET” framework, and others. Code modifier 12 may insert executable instructions into various types of object categories of its host binary software code 22, such as user interface object category, a data tier object category, or database object categories conforming to open database connectivity (ODBC), Java database connectivity (JDBC) database drivers, or other standards.

Computing system 18 executing code modifier 12 may be any suitable type, such as a network coupled computing system or a stand-alone computing system. An example stand-alone computing system 18 may be a personal computer, laptop computer, or mainframe computer capable of executing instructions of code modifier 12. An example of a network computing system may include multiple computers coupled together via a network, such as a local area network (LAN), a metropolitan area network (MAN), or a wide area network (WAN). Further details of other systems that may be used with various embodiments are described with reference to FIG. 7.

FIGS. 2A and 2B are illustrations showing a portion of binary software code 22 and a portion of modified software code 24, respectively. Binary software code 22 typically includes multiple code segments 28 that, when executed by its host computing system, perform various operations in support of the overall functionality provided by binary software code 22. In the Java programming language, certain code segments 28 may be referred to as methods. In other programming languages, code segments 28 may be referred to by other names, such as functions, routines, procedures, and the like.

Each code segment 28 may include an entry point 30 indicating its beginning and an exit point 32 indicating its ending point. When binary software code 22 is executed, code segment 28 may be called by accessing the first instruction at it entry point 30. Each instruction is subsequently executed until the last instruction at exit point 32 is encountered. In many cases, code segments 28 of compiled binary software code 22 may have a structure that is relatively similar to each other. For example, the Java programming language incorporates a class data structure that conforms to a Java virtual machine (JVM) specification. Thus, code segments 28 may exist in a common, identifiable structure. In particular embodiments, code modifier 12 may exploit this similarity to identify specific code segments 28 to be modified.

Code modifier 12 may insert executable instructions at the entry point 30 of code segment 28 and/or executable instructions 34 at the exit point 32 of code segment 28. For executable instructions 34 inserted at the entry point 30, pointers included in the class data structure of code segment 28 may be modified such that when called, execution of code segment 28 may commence by initially executing executable instructions 34 at entry point 30. For executable instructions 34 inserted at exit point 32, instructions of the code segment 28 may be modified such that executable instructions 34 are executed prior to returning control back to code segment's 28 calling routine. In particular embodiments, the end result of insertion of the executable instructions may be an addition, removal, or modification of the code.

Although the term “modification” has been used, it should be understood that in certain embodiments, a segment 28 or segments 28 are “wrapped” such that the execution of the whole of the wrapped segments 28 is modified.

In certain embodiment, code modifier 12 searches through the machine language instructions of binary software code 22 to determine code segments 28 to be modified.

Code segments 28 to be modified may determined by comparing certain sequences of machine language instructions with known sequences of machine language instructions that may be generated by compilers that may have been used to compile the binary software code 22. Non-limiting examples of techniques that may be used with various embodiments to determine code segments 28 to be modified and/or insert code are described in U.S. Pat. No. 7,512,935, issued on Mar. 31, 2009, and entitled “ADDING FUNCTIONALITY TO EXISTING CODE AT EXITS,” which is hereby incorporated by reference in its entirety. Other methods and/or techniques for determining insertion points for code may additionally be utilized.

FIG. 3 is a diagram showing an example embodiment in which code is injected into binary software code to provide identity and access management (IAM) functionality and/or governance functionality. In this embodiment, the modified software code 24a may be executed on a suitable host computing system 38. Host computing system 38 may be a stand-alone computing system or a network computing system such as described above with reference to FIG. 1. Alternatively, host computing system 38 may be any of the systems described with reference to FIG. 7. Executable instructions 34a inserted into modified software code 24a may generally regulate access to associated code segment 28 according to a desired IAM functionality. As referenced above, this may include obtaining the Identification of a “user” to determine, according to an IAM “Policy,” what “Resources” that particular “user” may access. As indicated above, “user” may generally refer to a person, entity, object or device, capable of using the modified software code 24. For example, a user may be a person accessing the modified software code 24 through a computer. Alternatively, the user may be the computer or software, itself, programmed to access the code.

As a non-limiting IAM example, executable instructions 34a may implement a multi-level security (MLS) scheme for its associated code segment 28. Multi-level security usually incorporates a multi-tiered security scheme in which users have access to information managed by the enterprise based upon one or more authorization levels associated with each user. For example, enterprises, such as the government, utilize a multi-level security scheme that may include secret, top secret (TS), and various types of top secret/sensitive compartmented information (TS/SCI) security levels. In some cases, older versions of legacy binary software code 22 do not implement multi-level security. Due to this reason, their use may be limited with modern secure computing systems. Thus, certain embodiments of code modifier 12 may provide advantages in that older, legacy binary software code 22 may be modified to implement multi-level security without modification and re-compilation of its associated source code. Although the above non-limiting IAM example has been provided, it should be expressly understood that the inserted code may be used for other IAM and/or governance functions.

In one embodiment, executable instructions 34a may call a policy decision point (PDP) 40 to determine further appropriate steps to take. In particular embodiments, the PDP 40 may be remote from the host computing system 38. In other embodiments, the PDP 40 may be local to the host computing system 38. In yet other embodiments, the PDP 40 may be embedded in the modified software code 34a with the portion of the PDP 40 running in the same application processing space as the modified software code 34a. In yet further embodiments, at least a portion of the PDP 40 may be imbedded in the modified software code, referencing external code when necessary for implementation of a particular policy.

In operation, the executable instructions 34a corresponding to the IAM may pass necessary data (e.g., identification and/or application parameters) to the PDP (remote, local, or embedded in the modified source code 34a) for a determination on how to further proceed. In response to the executable instructions 34a contacting the PDP 40, any of a variety of actions can take place at the executable instructions 34a, depending on whether the particular policy parameters are rejected or accepted. Examples include, but are not limited to, allowing code to be executed, skipping code, and allowing additional code to be invoked.

Policy decision point 40 may generally include, but is not limited to, one or more policies that associate specific user identities or classes of user identities with specific levels of access to particular levels of resources. In one embodiment, policy decision point 40 may be an extensible access control markup language (XACML) authorization service in which executable instructions 34a generate and receive (XACML) messages suitable for authenticating access to code segment 28.

As indicated, in one embodiment, executable instructions 34a may include an embedded policy decision point 40 or a policy decision point 40 that runs in the same application processing space as the executable instructions 34a. In particular embedded policy embodiments, policy decision information may be provided to code segment 28 without external calls, for example, to a remote PDP. In other words, the code needed to implement the policy may be embedded and enforced in the executable instructions 34a. In such an embodiment, the PDP may be running in the same process space as the application. Embedding policies in executable instructions 34a may be useful when access to a suitable policy decision point 40 may be difficult to achieve in some cases. For example, a particular operation performed by binary software code 22 is to be limited to a specific user whose user ID is “James Bond.” Executable instructions 34a may be inserted into one or more code segments 28 that include the user ID=“James Bond” as a policy. When executed, the executable instructions 34a may regulate access to code segments 28 associated with the particular operation to only the user having a user ID of “James Bond.”

In yet another embodiment, at least a portion of the policy decision point 40 may be embedded within the executable instructions 34a, pulling (as necessary) data from external sources. Similar to the above, in this embodiment, the portion of the policy decision point 40 may run in the same application processing space as the executable instructions 34a

As a non-limiting example of injecting code to provide particular IAM and/or governance functionality, in one embodiment, code modifier 12 may be used to provide language level replacement of legacy authorization systems. For example, a company deploys a proprietary authorization service having an application program interface (API) from which the proprietary authorization service may be called. Subsequently, numerous applications are written that call the proprietary authorization service through this application program interface. Later on, the company deploys a differing authorization service with the goal of replacing the existing proprietary authorization service. Several of the applications, however, have matured to the point that re-compiling from source code is generally impractical. Thus, code modifier 12 may be used to discover the legacy application program interface calls and replace them with application program interface calls to the new authorization service.

As another non-limiting example, in one embodiment, code modifier 12 may be used to insert licensing logic or replace existing licensing logic in an existing binary software code 22 without re-compiling from source code. Licensing logic included in a binary software code 22 may restrict the operation of certain features of binary software code 22 based upon one or more licensing rules associated with the use of binary software code 22. In another embodiment, code modifier 12 may be used to insert licensing logic or replace licensing logic in a binary software code 22 that is configured to be executed on a stand-alone computing system or from a network server and executed on or more client computing systems.

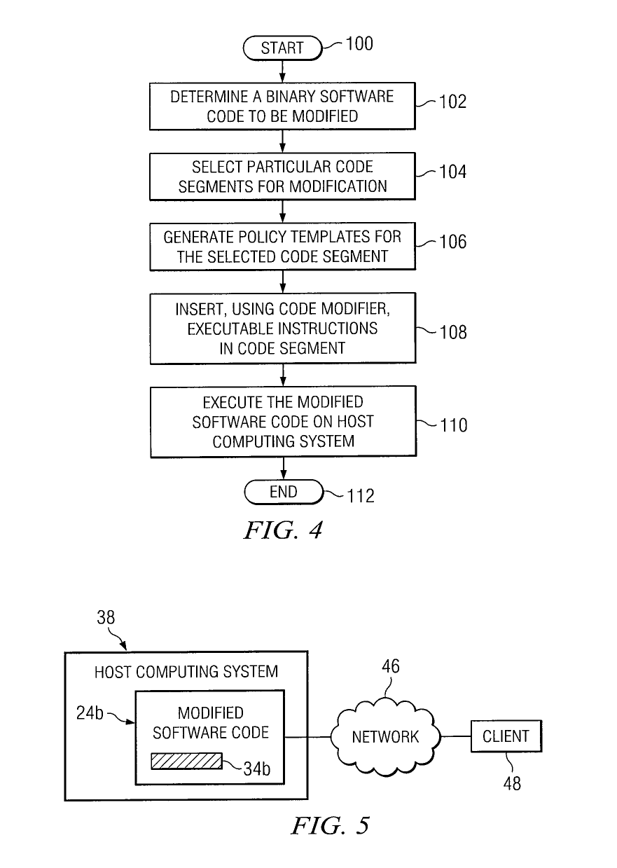

FIG. 4 is a flowchart showing one embodiment of a series of actions that may be performed to inject identity and access management (IAM) logic and governance logic into binary software code 22. In act 100, the process is initiated.

In act 102, a binary software code 22 is chosen for modification. Binary software code 22 may be any type that has been compiled by a compiler. In some embodiments, the source code used to compile binary software code 22 may be difficult to obtain, and/or the environment associated with its compilation may not be readily available. Certain cases may exist where continuing development of the binary software code 22 is no longer active. That is, support for the binary software code 22 no longer exists.

In act 104, particular code segments 28 are selected for modification. Any of variety of techniques may be used to identify particular code segments for modification. As one non-limiting example, code may be inspected using Java's reflection capabilities. Further, in particular embodiments, input conditions, output conditions, or various attributes or variables, associated with operation of the particular code segment 28 may be analyzed or inspected. The inspection may yield contextual information which may then be used to determine insertion points for code. In particular embodiments, the code modifier 12 may provide sufficient information about input/output variables and other information associated with code segments 28 to provide insertion of executable instructions 34a that implement security and governance logic into binary software code 22.

In some embodiments, binary software code 22 may include a policy decision engine that regulates access to various portions of binary software code 22. Code modifier 12 may insert executable instructions into certain code segments 28 of the policy decision engine to enhance its level of control over particular portions of binary software code 22. That is, the policy decision engine of binary software code 22 may be modified to enhance its granularity of control over particular operations performed by binary software code 22.

In act 106, one or more access management policy templates may be generated for the selected code segment 28. Access management policy templates may be used to associate a specified access level according to information passed to code segment 28. For example, it may have been determined during inspection of information provided by code modifier 12 that certain variables including a user ID value and a management rank value associated with the user ID value are to be passed to code segment 28 when it is called. Using this information, an access management policy template may be generated that associates access rights of code segment 28 with values of user ID and/or management rank that are passed to code segment 28 during operation.

In act 108, code modifier 12 is used to insert executable instructions 34a before and/or after the selected code segment 28. In this particular embodiment, executable instructions 34a are configured to provide IAM functionality or governance functionality to the code segment 28. Once modified, code modifier 12 may store the modified software code 24a in storage 20.

Code modifier 12 may insert executable instructions into any suitable type of code segment 28, such as model, view, controller objects, and/or database drivers for regulating access according to the specified authorization scheme. For example, executable instructions 34 may be inserted into a code segment 28 that manipulates information viewed on a display. Thus, code segment 28 may be configured to display certain types of information on display according to an authorization level of the user. As another example, executable instructions 34a may be inserted into a code segment 28 that controls functionality of certain features of binary software code 22. Thus, code segment may be configured to regulate operation of certain features, such as interactive access among differing types of code segments 28. As another example in which binary software code 22 has been compiled from a source code written in a Java programming language, executable instructions 34a may be inserted into a method to restricts access from certain types of objects.

Executable instructions 34a may include control instructions to restrict access according to specified authorization scheme. For example, in one embodiment, executable instructions may provide a certain return code that indicates to the calling routine that access rights to the requested information was granted while an exception may be thrown if access rights were rejected. In this particular embodiment, additional executable instructions 34a may be inserted in the exception table of the binary software code 22 to perform certain operations in the event that an unauthorized access attempt was performed.

In act 110, the modified software code 24a is executed on a suitable host computing system 38. During its execution, calls to the particular code segment 28 may be regulated according to executable instructions 34a. In one embodiment, executable instructions 34a may access a suitable policy decision point 40 (remote, local, or embedded in modified software code 24a).

Execution of executable instructions 34a continues throughout operation of modified software code 24a to provide multi-level security access. When use of modified software code 24a is no longer needed or desired, the process ends in act 112.

FIG. 5 is a diagram showing another example embodiment in which code is injected into binary software code to expose the binary software code as a web service interface (including web service client and a web service endpoint). The executable instructions 34b inserted into modified software code 24b may expose its associated code segment 28 (FIG. 2A) as a web service operation. More particularly, in particular embodiments, the modified software code 24b may expose associated code segment 28 (FIG. 2A) as a web service endpoint. Additionally, in particular embodiments, the existing code segment 28 may also be exposed as a web service client that accesses information from a remotely configured web service through the network 46.

Existing implementations of binary software code 22 (FIG. 2A) often include code segments 28 whose access to or from other systems may be limited. Certain legacy implementations of binary software code 22 may possess useful features; however, these features may not be web service aware for providing access to information from remotely configured clients 48, or allowing access to remotely configured servers through a network 46, such as a virtual private network (VPN), an intranet, or the Internet. For example, a particular code segment 28 of binary software code 22 implemented using the COBOL language may be used to perform various calculations based upon the current price of a particular stock. Inserting executable instructions 34b before and/or after the particular code segment 28 may be used to generate web service interface logic which would be able to process an external extensible markup language (XML) request that accesses this information from a particular web service client.

In one embodiment, executable instructions 34b may modify certain code segments 28 of binary software code to behave as web services operating in a service oriented architecture (SOA) or a software as a service (SaaS) infrastructure. In another embodiment, web services implemented by executable instructions 34b conform to the web services description language (WSDL) for interoperability among other servers and/or clients 48 coupled to network 46.

Client 48 may include any suitable type of application coupled to network 46 that accesses, manipulates, and/or uses information provided by code segment 28. Examples of types of clients 48 include, but are not limited to, those used with controlled information publishing applications, enterprise search portals, access control service applications, knowledge discovery applications, or knowledge management applications.

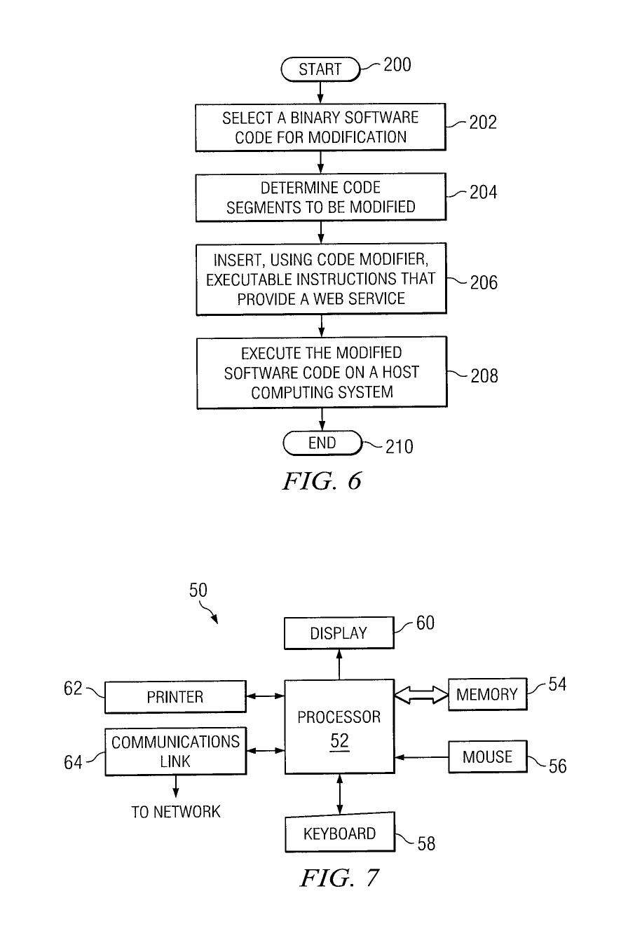

FIG. 6 is a flowchart showing one embodiment of a series of actions that may be performed to inject code into binary software code in order to expose the binary software code as a web service interface. In act 100, the process is initiated.

In act 202, a binary software code 22 is chosen for modification to implement code segment 28 as a web service. In one embodiment, one or more code segments 28 may be modified to create a web service functioning as a client that may access a server coupled to the modified software code 24b through a network 46. In another embodiment, the one or more code segments 28 may be modified to create a web service functioning as a web service endpoint for access by clients coupled to the modified software code 24b through a network 46.

In act 204, one or more code segments 28 of binary software code 22 are selected for modification. Any of variety of techniques may be used to identify particular code segments for modification. As one non-limiting example, code may be inspected using Java's reflection capabilities. Further, in particular embodiments, the code modifier 12 may provide sufficient information about input/output variables and other information associated with code segments 28 to provide insertion of executable instructions 34b that implement security and governance logic into binary software code 22.

In particular embodiments, input conditions, output conditions, and/or variables that may be analyzed to determine the appropriate location for a web service application program interface (API). As non-limiting examples, in particular embodiments, Java 2 platform enterprise edition (J2EE) applications, such as Websphere™, Weblogic™, or servlet containers such as Tomcat™ can be inspected. The inspection may yield contextual information which may then be used to determine insertion points for the web service logic.

In act 206, code modifier 12 is used to insert executable instructions 34b before and/or after the selected one or more code segments 28 to implement a web service API. Code modifier 12 then stores the binary software code 22 and inserted executable instructions 34b as a modified software code 24b in mass storage system 20.

In act 208, the modified software code 24b is executed on a suitable host computing system 38. During its execution, calls to the one or more code segments 28 may be intercepted by executable instructions 34b to provide an API for serving information to remotely configured clients 48, or obtaining information from remotely configured servers coupled through network 46.

Execution of executable instructions 34b continues throughout operation of modified software code 24b to provide web service aware APIs to other clients 48 and servers. When use of modified software code 24b is no longer needed or desired, the process ends in act 210.

Modifications, additions, or omissions may be made to the methods of FIG. 4 or 6 without departing from the scope of the disclosure. The methods may include more, fewer, or other acts. For example, other executable applications executed on host computing system 38 may be modified to utilize enhanced functionality provided by the modified software code 24b of FIG. 3 or the modified software code 24b of FIG. 5. Additionally, code modifier 12 may be modified to detect particular patterns in binary software code 22 indicating the presence of particular algorithms that may be implemented with a multi-level security scheme or as a web service aware API.

FIG. 7 presents an embodiment of a general purpose computer 50 that may be used to perform one or more operations of various embodiments. The general purpose computer 50 may generally be adapted to execute any of the known OS2, UNIX, Mac-OS, Linux, and Windows Operating Systems or other operating systems. The general purpose computer 50 in this embodiment comprises a processor 52, a memory 54, a mouse 56, a keyboard 58, and input/output devices such as a display 60, a printer 62, and a communications link 64. In other embodiments, the general purpose computer 50 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 52, may manage the operation of the general purpose computer 50. Examples of the processor 52 include one or more microprocessors, one or more applications, and/or other logic. Certain logic may include a computer program, software, computer executable instructions, and/or instructions capable being executed by the general purpose computer 50. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 54. The memory 54 may comprise one or more tangible, computer-readable, and/or computer-executable storage medium. Examples of the memory 54 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 64 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

Although the illustrated embodiment provides one embodiment of a computer that may be used with other embodiments, such other embodiments may additionally utilize computers other than general purpose computers as well as general purpose computers without conventional operating systems. Additionally, embodiments may also employ multiple general purpose computers 50 or other computers networked together in a computer network. For example, multiple general purpose computers 50 or other computers may be networked through the Internet and/or in a client server network. Embodiments may also be used with a combination of separate computer networks each linked together by a private or a public network.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A binary code modification system comprising:
a code modifier comprising instructions stored in a memory and executable on a computer, the code modifier operable to:
access a binary software code comprising one or more code segments; and
generate a modified software code by inserting one or more executable instructions into the binary software code, the one or more executable instructions operable to provide at least one of identity and access management (IAM) functionality or governance functionality to the modified software code.

2. The binary code modification system of claim 1, wherein the at least one of identity and access management (IAM) functionality or governance functionality includes a policy that determines whether authorization can granted to at least one resource.

3. The binary code modification system of claim 1, wherein the one or more executable instructions are operable to access policies associated with the authorization of a user from an external policy decision point (PDP).

4. The binary code modification system of claim 1, wherein the one or more executable instructions are operable to access and enforce policies associated with the authorization of a user, the policies embedded directly in the executable instructions.

5. The binary code modification system of claim 1, wherein the one or more executable instructions are operable to access and enforce policies associated with the authentication of a user, the policies embedded directly in the executable instructions.

6. The binary code modification system of claim 1, wherein the binary software code has been compiled from a source code written in a Java programming language.

7. The binary code modification system of claim 1, wherein the binary software code has been compiled from source code that conforms to the Java 2 Enterprise Edition (J2EE) server framework, to the common business oriented language (COBOL) software code, or to the Microsoft™ .NET framework.

8. The binary code modification system of claim 1,
wherein the code modifier is operable to modify at least some of the one or more code segments.

9. The binary code modification system of claim 1, wherein the code modifier is operable to insert the one or more executable instructions at the beginning of a code segment.

10. The binary code modification system of claim 1, wherein the code modifier is operable to insert the one or more executable instructions at the end of a code segment.

11. A binary code modification method comprising:
accessing a binary software code comprising one or more code segments; and
generating a modified software code by inserting one or more executable instructions into the binary software code, the one or more executable instructions operable to provide at least one of identity and access management (IAM) functionality or governance functionality to the modified software code.

12. The binary code modification method of claim 11, wherein the at least one of identity and access management (IAM) functionality or governance functionality includes a policy that determines whether authorization can granted to at least one resource.

13. The binary code modification method of claim 11, wherein the one or more executable instructions are operable to access policies associated with the authorization of a user from an external policy decision point (PDP).

14. The binary code modification method of claim 11, wherein the one or more executable instructions are operable to access and enforce policies associated with the authorization of a user, the policies embedded directly in the executable instructions.

15. The binary code modification method of claim 11, wherein the binary software code has been compiled from a source code written in a Java programming language.

16. The binary code modification method of claim 11, wherein the binary software code has been compiled from source code that conforms to the Java 2 Enterprise Edition (J2EE) server framework, to the common business oriented language (COBOL) software code, or to the Microsoft™ .NET framework.

17. The binary code modification method of claim 11, wherein the code modifier is operable to modify at least some of the one or more code segments.

18. The binary code modification method of claim 11, wherein the one or more executable instructions are inserted at the beginning of a code segment.

19. The binary code modification method of claim 11, wherein the one or more executable instructions are inserted at the end of a code segment.

20. The binary code modification method of claim 11, wherein the insertion of the one or more executable instructions into the binary software code is carried out without a recompiling process.
